(19) United States
(12) Patent Application Publication
(10) Pub. No.: US 2009/0301272 A1
(43) Pub. Date: Dec. 10, 2009

(54) CABLE PLIERS STRUCTURE

(75) Inventor: Ching-Jen CHEN, Taipei County (TW)

Correspondence Address: RABIN & Berdo, PC, 1101 14TH STREET, NW, SUITE 500, WASHINGTON, DC, 20005, US

(73) Assignee: LI-YAO INDUSTRIAL CO., LTD., Taipei Hsien (TW)

(21) Appl. No.: 12/133,411

(22) Filed: Jun. 5, 2008

(51) Int. Cl. B25B 7/02

(52) U.S. Cl. 81/304

(57) ABSTRACT

A cable pliers structure includes a left plier body and a right plier body pivotally connected to each other. The right plier body has an adjusting region. The left plier body is connected with a drive seat movably disposed on one side of the adjusting region. A pressing block is disposed at the top of the drive seat. A clamping component is disposed in the adjusting region and has a clamp base that is movable relative to the pressing block. When the relative distance between the clamp base and the pressing block is changed, that is, the clamp base moves away from or approaches the pressing block, the distance is equivalent to the specification and dimension of a cable connector to be used. Therefore, the cable pliers structure is suitable for cable connectors of various specifications and dimensions through adjusting the distance, without replacing the pressing block.

### BACKGROUND OF THE INVENTION

1. Field of the Invention

The present invention relates to a cable pliers structure, and in particular, to a cable pliers structure, which is capable of adjusting a relative distance between a clamp base and a pressing block according to the specification and dimension of a cable connector.

2. Related Art

Signal transmission via cables has been commonly applied in the current society. For example, the signal line for data transmission in a cable television or computer is a cable. In order to connect the cable to the device, the cable has a cable connector connected on each end thereof, so as to enable the cable to be connected to the device. Currently, the cable is connected with the cable connector through using a cable clamping tool. There are various types of cable clamping tools commercially available on the market. Related designs have been disclosed in Taiwan Patent Publication NO. 534510 and US Patent Publication NO. 5941120.

However, the specification and dimension of cables and cable connectors varies depending upon different apparatuses. The above designs are merely directed to connecting and fixing the cable with the cable connectors of a single specification and dimension, but cannot provide connection for cables and cable connectors of various different specifications and dimensions. Accordingly, Taiwan Patent Publication NO. M264738, entitled “Cable Pliers Structure”, proposes a pair of cable pliers for connecting cables with cable connectors of various different specifications and dimensions by means of replacing the pressing block.

However, in the above cable pliers structure, the connection between the cables and cable connectors of various specifications and dimensions is achieved by replacing the pressing block. However, the pressing blocks are likely to be lost in usage or the arranged pressing block is not matched with the specification and dimension of the actually used cable and the cable connector, and as a result, there are difficulties when the cable pliers structure is used.

### SUMMARY OF THE INVENTION

The current cable pliers structures are provided with a plurality of pressing blocks, so as to match with cable connectors of various specifications and dimensions. However, pressing blocks may be lost in usage or may be not matched with the specification and dimension of the actually-used cable and cable connector, which causes certain troubles for users in actual usage. In view of this, the present invention is directed to a cable pliers structure, which adjusts a relative distance between a clamp base and a pressing block to cater to the specification and dimension of the actually used cable and cable connector.

The cable pliers structure provided in the present invention includes a left plier body, a right plier body, a drive seat, a pressing block, and a clamping component. The left plier body is pivotally connected to the right plier body. The right plier body has an adjusting region at one end. One end of the drive seat is connected to the left plier body and movably disposed on one side of the adjusting region. The pressing block is disposed at the top of the drive seat. The clamping component includes a bearing base, a clamp base, and an adjusting rod. The bearing base is secured at one end of the adjusting region and is adjacent to the drive seat. The clamp base is disposed on the other end of the adjusting region and has a clamping hole corresponding to the position of the pressing block. The adjusting rod, such as a bolt, screws through the clamp base and is connected to the bearing base. When the adjusting rod is rotated, the clamp base moves relative to the bearing base, that is, the clamping hole moves away from or approaches the pressing block.

In the cable pliers structure according to the present invention, the adjusting rod is rotated to drive the clamp base to move relative to the bearing base, so as to change the distance between the clamping hole and the pressing block, which is equivalent to the specification and dimension of the actually used cable connector. In this way, the cable pliers structure of the present invention is suitable for cable connectors of various different specifications and dimensions through changing the distance between the clamping hole and the pressing block, which is convenient for usage.

### BRIEF DESCRIPTION OF THE DRAWINGS

The present invention will become more fully understood from the detailed description given herein below for illustration only, which thus is not limitative of the present invention, and wherein:

FIG. 1 is an exploded perspective view of a cable pliers structure according to a first embodiment of the present invention;

FIG. 2 is a perspective view of an external appearance of the cable pliers structure according to the first embodiment of the present invention;

FIG. 3 is a diagram showing motions of the cable pliers structure according to the first embodiment of the present invention;

FIG. 4 is another diagram showing motions of the cable pliers structure according to the first embodiment of the present invention;

FIG. 5 shows motions of the cable pliers structure under a closed status according to the first embodiment of the present invention;

FIG. 6 shows motions of the cable pliers structure according to the first embodiment of the present invention, in which the clamp base is adjusted;

FIG. 7 is a perspective view of an external appearance of a cable pliers structure according to a second embodiment of the present invention;

FIG. 8 is an exploded perspective view of the cable pliers structure according to the second embodiment of the present invention;

FIG. 9 is an exploded perspective view of a clamping component in the cable pliers structure according to the second embodiment of the present invention;

FIG. 10 is an enlarged exploded perspective view of a drive seat and a positioning slice in the cable pliers structure according to the second embodiment of the present invention;

FIG. 11 is a partial enlarged sectional view of the drive seat and the positioning slice in the cable pliers structure according to the second embodiment of the present invention;

FIG. 12 is a top view of the cable pliers structure according to the second embodiment of the present invention; and

FIG. 13 is a top view of the cable pliers structure according to the second embodiment of the present invention, when the clamping part is actuated.

### DETAILED DESCRIPTION OF THE INVENTION

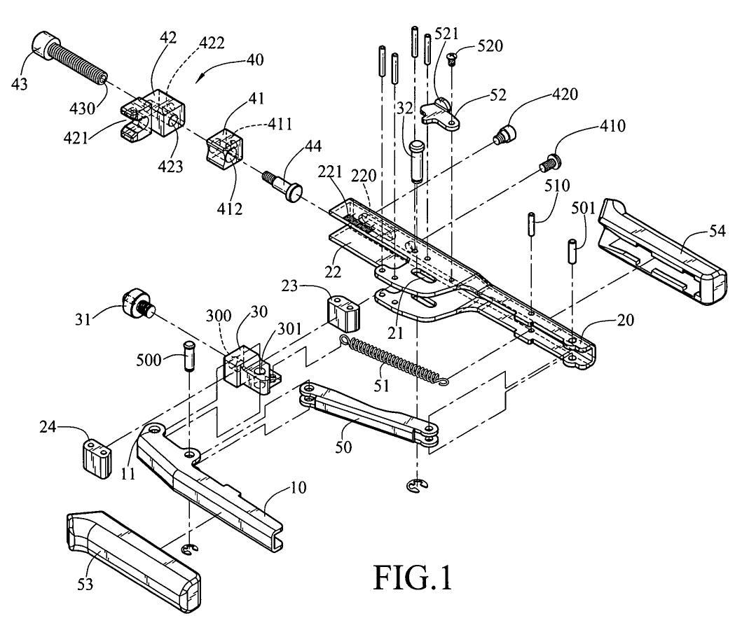

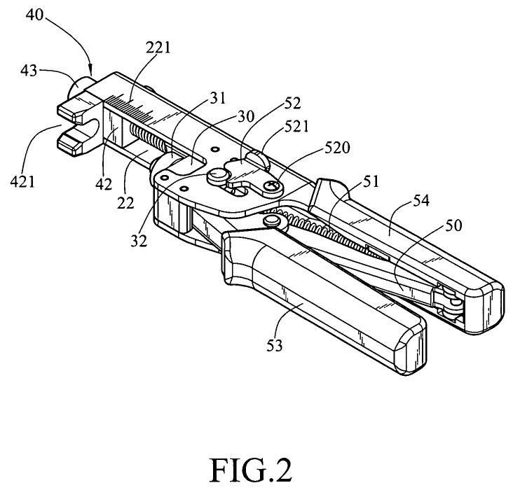

FIGS. 1 and 2 are schematic views of a cable pliers structure according to a first embodiment of the present invention. The cable pliers structure includes a left plier body 10, a right plier body 20, a drive seat 30, a pressing block 31, a clamping component 40, a connecting rod 50, an elastic element 51, a stopping element 52, a sheath for the left plier body 53, and a sheath for the right plier body 54.

The left plier body 10 has a locking hole 11 and the right plier body 20 has an elongate hole 21 corresponding to the locking hole 11. An adjusting region 22 extends from one end of the right plier body 20 and has a guide hole 220. The adjusting region 22 has scales 221 on an external surface thereof. Stoppers 23 and 24 are respectively secured on each side of the elongate hole 21.

The drive seat 30 is movably disposed on one side of the adjusting region 22 and located between the two stoppers 23 and 24. The drive seat 30 has a buried cavity 300 at the top end thereof and has a via hole 301 on one side. A latch 32 passes through the elongate hole 21, the locking hole 11, and the via hole 301, so that the left plier body 10, the right plier body 20, and the drive seat 30 are jointed together to have an actuating relation with each other. The pressing block 31 is detachably disposed in the buried cavity 300.

The clamping component 40 includes a bearing base 41, a clamp base 42, an adjusting rod 43, and a bolt 44. The bearing base 41 has a screw hole 411 and a through hole 412. A screw 410 passes through the right plier body 20 and is screwed into the screw hole 411, so that the bearing base 41 is locked to one end of the adjusting region 22 and is adjacent to the pressing block 31. The clamp base 42 has a positioning screw hole 422, and has a guide screw hole 423 corresponding to the position of the through hole 412 in the bearing base 41. A positioning screw 420 passes through the guide hole 220 and is screwed into the positioning screw hole 422, so that the clamp base 42 is disposed at the other end of the adjusting region 22. The clamp base 42 has a clamping hole 421 corresponding to the position of the pressing block 31. The adjusting rod 43 is a bolt screwed through the guide screw hole 423 of the clamp base 42, and has a connecting screw hole 430 at the screwing end thereof. The bolt 44 passes through the through hole 412 in the bearing base 41 and is screwed into the connecting screw hole 430 of the adjusting rod 43, so that the adjusting rod 43 and the bearing base 41 are connected with each other.

The two ends of the connecting rod 50 are respectively connected to the left plier body 10 and the right plier body 20 through two fixtures 500 and 501. The connecting rod 50 limits the maximum movement range of the left plier body 10 with respect to the right plier body 20. The elastic element 51 may be a spring. One end of the elastic element 51 passes through a guide pillar 510 and is secured to the right plier body 20 and the other end is hooked to the drive seat 30.

The stopping element 52 is rotatably disposed on the right plier body 20 and connected to the right plier body 20 via a screw 520. A pulling portion 521 is disposed at one end of the stopping element 52 for pulling the stopping element 52.

The sheath for the left plier body 53 and the sheath for the right plier body 54 may be soft sheaths made of a material like rubber, which are respectively mounted on one end of the left plier body 10 and the other end of the right plier body 20, so as to enable the users to feel more comfortable when gripping the pillers.

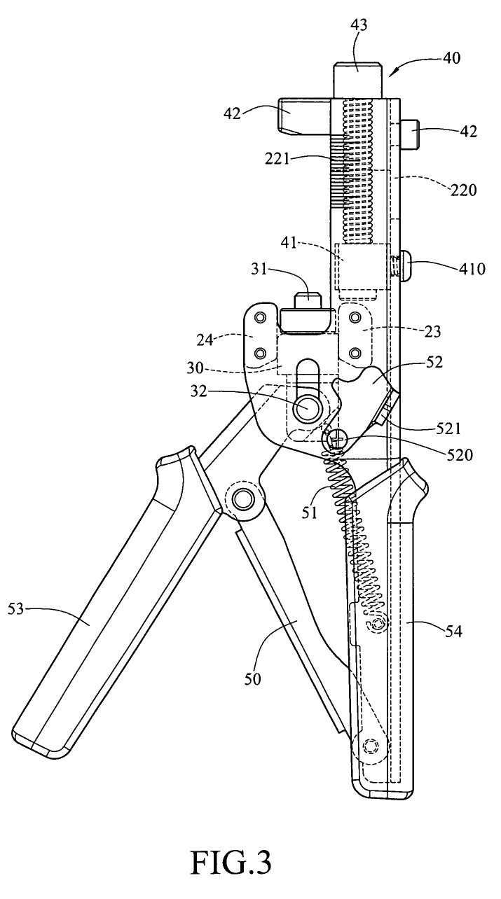

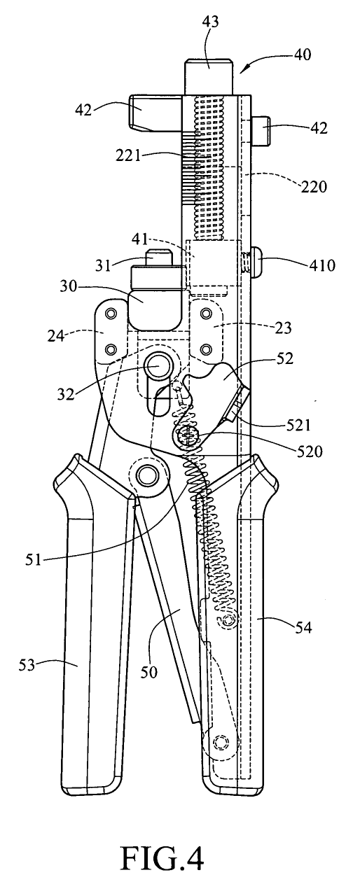

FIGS. 3 and 4 show motions of the cable pliers structure according to the first embodiment of the present invention. A coaxial cable is taken as an example in this embodiment. The coaxial cable is placed into the clamping hole 421, and a cable connector is placed between the pressing block 31 and the clamping hole 421. Then, referring to FIG. 3, the left plier body 10 has a first position where it keeps a predetermined distance away from the right plier body 20 and a second position where it leans against the right plier body 20. When the user applies a force on the left plier body 10 to move the left plier body 10 towards the direction of the right plier body 20 to reach the second position leaning against the right plier body 20, the left plier body 10 drives the drive seat 30 to move along an opening direction of the elongate hole 21 in the right plier body 20. The two stoppers 23 and 24 ensure the drive seat 30 to move along such a specific direction. Meanwhile, the drive seat 30 also drives the pressing block 31 to move together. In the travel of such a displacement, the left plier body 10 drives the pressing block 31 to move from an uncompressed position to a compressed position, so that the coaxial cable is tightly put in the cable connector previously placed between the pressing block 31 and the clamping hole 421. In this way, the coaxial cable is connected to the cable.

When the left plier body 10 is applied with a force to move from the first position to the second position, the drive seat 30 is driven into displacement as well, and the moving drive seat 30 stretches the elastic element 51. Therefore, once the force applied to the left plier body 10 is removed, the stretched elastic element 51 offers a rebounding force to make the left plier body 10 back to the first position, i.e., its initial position.

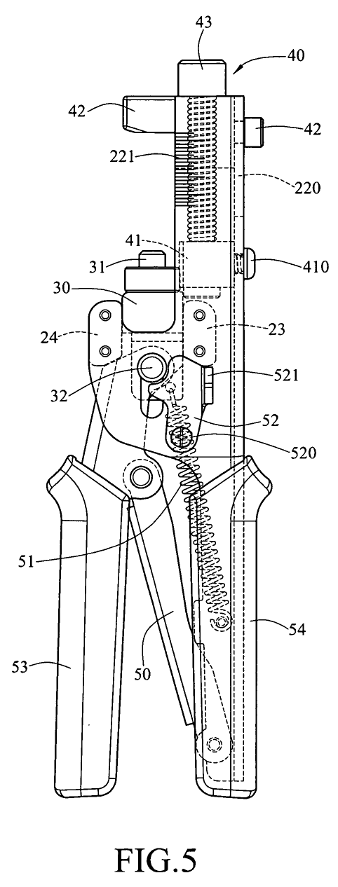

FIG. 5 shows another motion of the cable pliers structure according to the first embodiment of the present invention. When the cable pliers structure of the present invention has accomplished the connection between the coaxial cable and the cable connector, and the user wants to take the cable pliers structure along to somewhere else, the user can apply a force to move the left plier body 10 into the second position leaning against the right plier body 20, and pull the pulling portion 521, so that the other end of the stopping element 52 seizes the latch 32. In this way, the left plier body 10 is kept in the second position leaning against the right plier body 20 and the extension angle between the left plier body 10 and the right plier body 20 is reduced, which is convenient for being carried along.

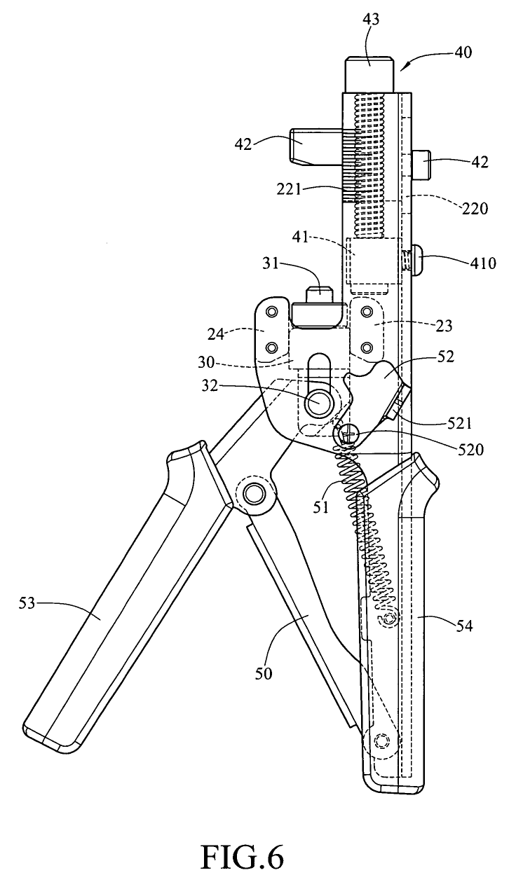

FIG. 6 shows another motion of the cable pliers structure according to the first embodiment of the present invention. The clamp base 42 is positioned on the right plier body 20 by a positioning screw 420, the clamp base 42 is combined with the rotation rod 43 through screwing, and the adjusting rod 43 is combined with the bolt 44 through screwing, so that such a structure enables the adjusting rod 43 to be rotated. As there are cable connectors of various specifications and dimensions, the present invention can adjust the relative distance between the pressing block 31 and the clamping hole 421, so as to cater to the cable connectors of various specifications and dimensions. The adjustment manner is achieved below in detail. First, the positioning screw 420 is loosened by screwing reversely and the adjusting rod 43 is rotated in accordance with the dimension and specification of the cable connector. As the adjusting rod 43 and the clamp base 42 are combined through screwing, the clamp base 42 can move relative to the bearing base 41 as the adjusting rod 43 is rotated, so that the distance between the clamping hole 421 and the pressing block 31 is adjusted to match with the specification and dimension of the cable connector to be used. After the adjustment, the positioning screw 420 is tightened, so that the clamp base 42 is tightly attached to the right plier body 20. In this way, when the cable pliers structure according to the present invention is used for combing the cable with the cable connector, the clamp base 42 would not be moved or slipped during the process of combining the cable with the cable connector, since the clamp base 42 is fixed by the positioning screw 420.

As discussed above, in the cable pliers structure according to the present invention, the adjusting rod 43 is rotated to move the clamp base 42 with respect to the bearing base 41, and thus, the clamping hole 421 is moved away from or approaches the pressing block 31. Therefore, the distance between the clamping hole 421 and the pressing block 31 is adjusted in accordance with the specification and dimension of the actually used cable connector, which is equivalent to the specification and dimension of the cable connector. In this way, the cable pliers structure according to the present invention can be used in combination with cable connectors of various specifications and dimensions, without replacing the pressing block 31.

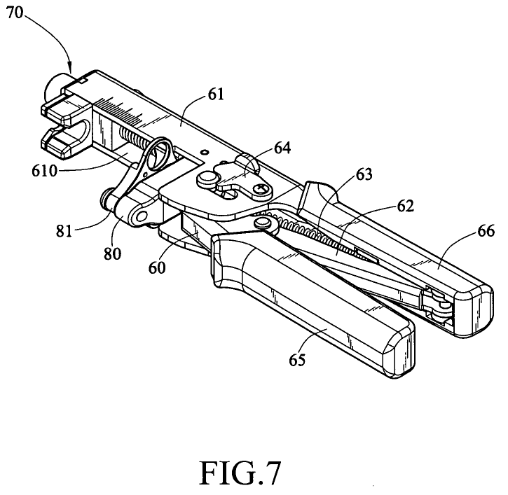

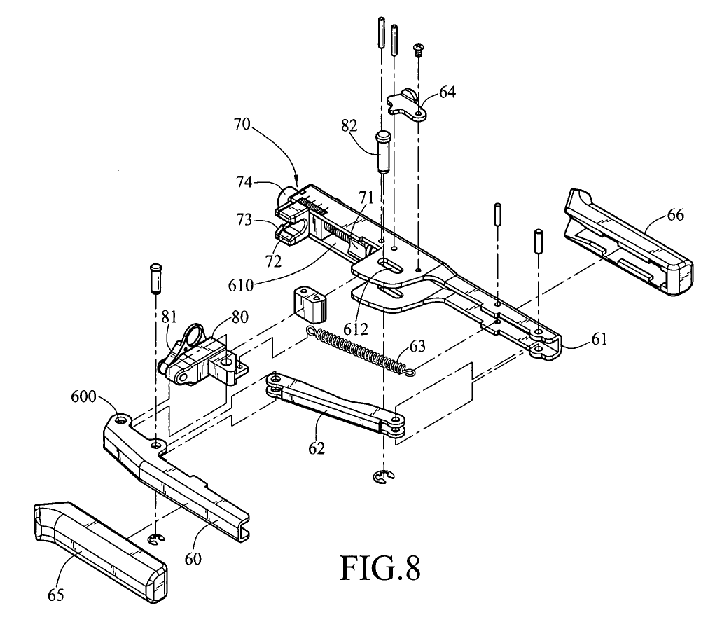

FIGS. 7 and 8 are schematic views of a cable pliers structure according to a second embodiment of the present invention. In this embodiment, merely the clamping component and the drive seat are modified and will be discussed below in detail, whereas the other means are similar to those in the first embodiment, which are only briefly described, since they are not the key point of the present invention.

The cable pliers structure includes a left plier body 60, a right plier body 61, a connecting rod 62, an elastic element 63, a stopping element 64, a sheath for the left plier body 65, a sheath for the right plier body 66, a clamping component 70, a drive seat 80, and a positioning slice 81.

The left plier body 60, the right plier body 61, the connecting rod 62, the elastic element 63, the stopping element 64, the sheath for the left plier body 65, and the sheath for the right plier body 66 are similar to those of the first embodiment in terms of composition, combination, and operating principle, which thus are not described herein repeatedly.

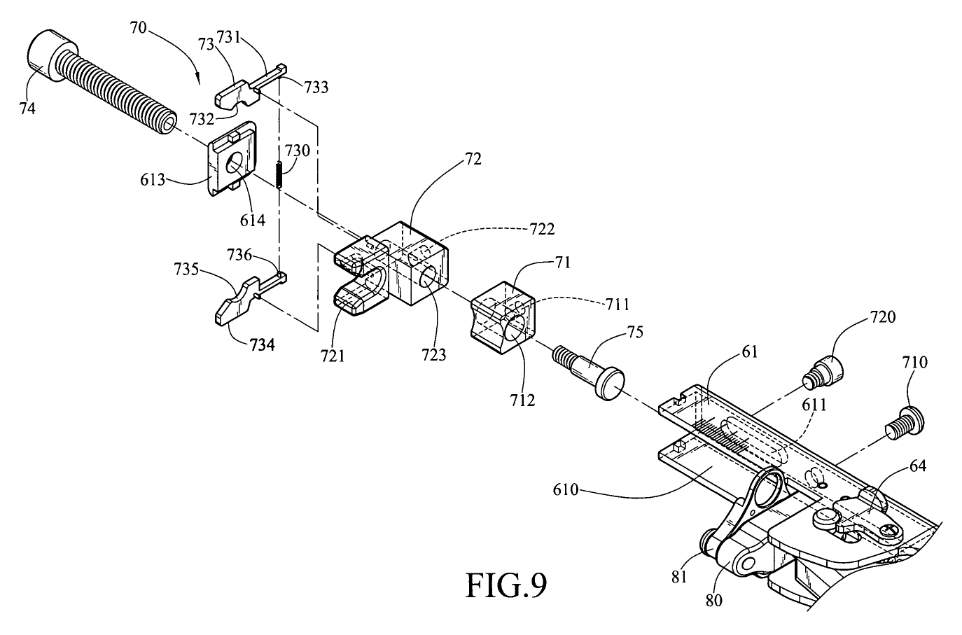

FIG. 9 is an exploded perspective view of a clamping component in the cable pliers structure according to the second embodiment of the present invention. A fixing slice 613 with a through hole 614 is disposed at one end of the adjusting region 610 for the right plier body 61.

The clamping component 70 includes a bearing base 71, a clamp base 72, a clamping part 73, an adjusting rod 74, and a bolt 75.

The bearing base 71 has a screw hole 711 and a through hole 712. A screw 710 passes through the right plier body 61 and is screwed in the through hole 712, so that the bearing base 71 is locked at one end of the adjusting region 610 and located in the right plier body 61.

The clamp base 72 has a positioning screw hole 722 and a guide screw hole 723 corresponding to the position of the through hole 712 in the bearing base 71. A positioning screw 720 passes through the guide hole 611 and is screwed in the positioning screw hole 722, so that the clamp base 72 with a clamping hole 721 is disposed at one end of the adjusting region 610.

The clamping part 73 includes a spring 730, a first piece 731, and a second piece 734. The first piece 731 and the second piece 734 are pivotally disposed on the clamp base 72 and correspond to each other. The first piece 731 has a first groove 732 and a first connection portion 733 and the second piece 734 has a second groove 735 and a second connection portion 736. The first groove 732 and the second groove 735 are opposite to each other and disposed on the clamping hole 721. The first groove 732 and the second groove 735 are combined to form a clamping region. The spring 730 is connected between the first connection portion 733 and the second connection portion 736. The adjusting rod 74 sequentially passes through the through hole 614 and the guide screw hole 723, and has a connecting screw hole 740 at the screwing end thereof. The bolt 75 passes through the through hole 712 in the bearing base 71 and is screwed in the connecting screw hole 740 of the adjusting rod 74, so that the adjusting rod 74 and the bearing base 71 are connected to each other.

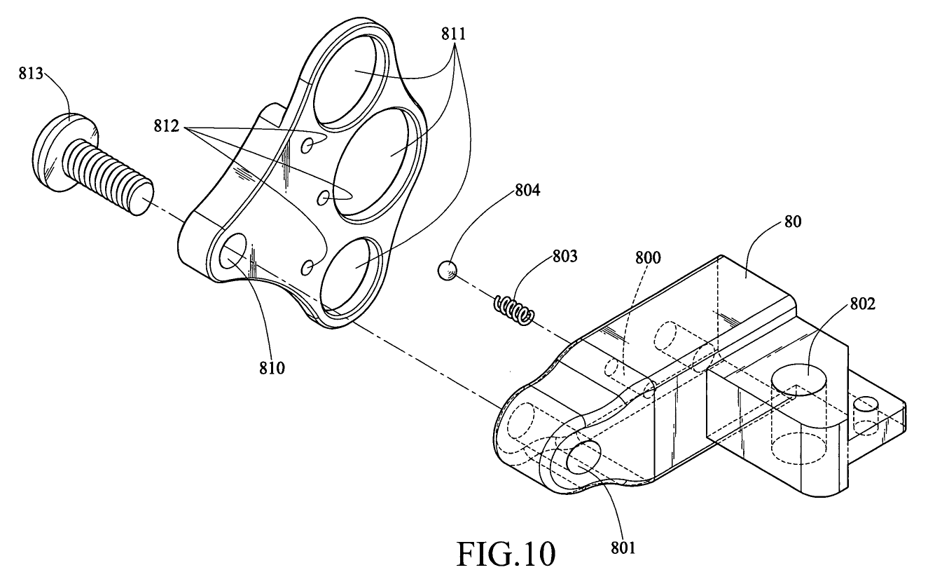

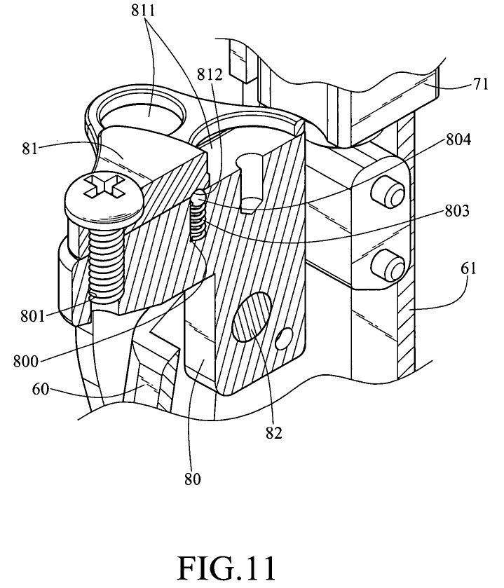

FIGS. 10 and 11 are schematic views of the drive seat and the positioning slice in the cable pliers structure according to the second embodiment of the present invention. The drive seat 80 is movably disposed at one side of the adjusting region 610, and has a buried cavity 800 and a screw hole 801 at the top end thereof. The drive seat 80 has a via hole 802 at one side thereof. A latch 82 passes through the elongate hole 612, the locking hole 600, and the via hole 802, so that the left plier body 60, the right plier body 61, and the drive seat 80 are jointed together and have an actuation relation with each other. A spring 803 and a bead 804 are disposed in the buried cavity 800.

The positioning slice 81 is pivotally disposed at the top end of the drive seat 80, and has a pivot hole 810 and a plurality of positioning holes 811. Each positioning holes 811 has a different aperture to match with the cable connectors of various specifications and dimensions. The positioning holes 811 correspond to the clamping hole 721. A screw 813 passes through the pivot hole 810 and is screwed in the screw hole 801, so that the positioning slice 81 is pivotally disposed on the drive seat 80. The positioning slice 81 has a plurality of positioning grooves 812 at the bottom thereof, and each positioning slice 812 is corresponding to a positioning hole 811 respectively, and provided for the bead 804 to be selectively chucked therein, so that the positioning slice 81 would not be moved or slipped in usage.

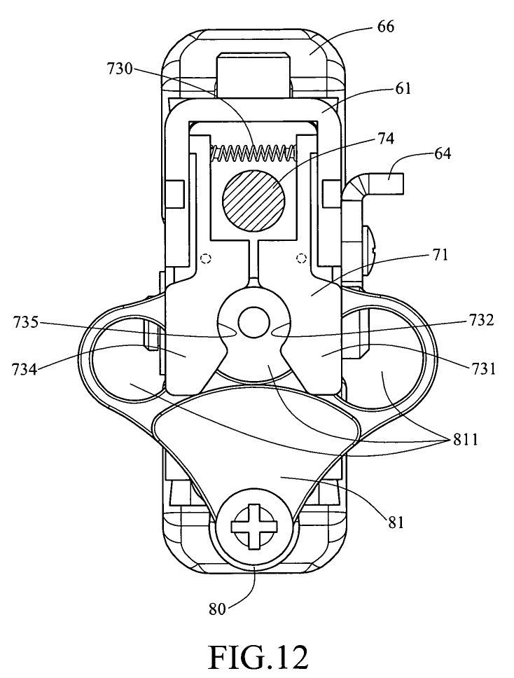

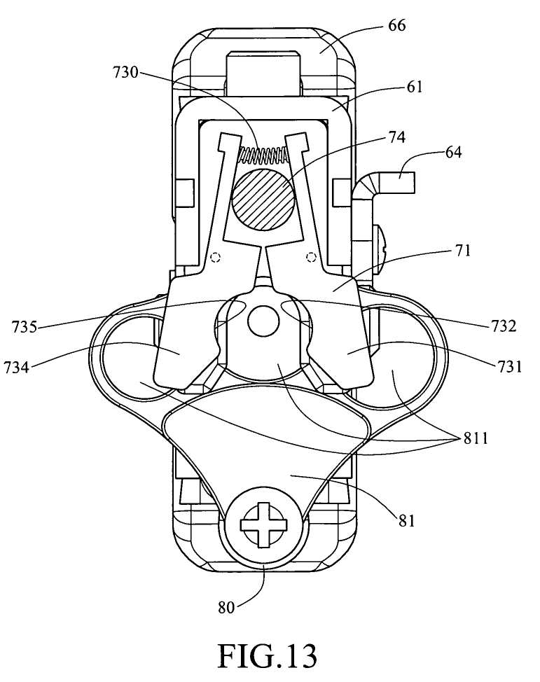

FIGS. 12 and 13 are top views of the cable pliers structure according to the second embodiment of the present invention. As shown in the figures, the clamping part 73 is in the initial position before a cable extends to the clamping region thereof. Once the cable extends to the clamping region and enters in the clamping hole 721, the first piece 731 and the second piece 734 are pushed by the cable to expand outwards. The spring 730 offers a rebounding force to make the first piece 731 and the second piece 734 clamp the cable firmly.

The position adjustment of the clamp base 72 has been discussed in the first embodiment, which thus will not be described any more. However, the specification and dimension of the cable connector varies depending on the actual situation. When the specification and dimension of the cable connector varies, the position of the clamp base 72 may be adjusted and the positioning slice 81 may be flipped, so that the aperture of the positioning hole 811 matches with the dimension and specification of the cable connector. Once the aperture of the positioning hole 811 matches with the dimension and specification of the cable connector, the flipping motion of the positioning slice 81 is stopped. At this time, the bead 804 pushed by the spring 803 is chucked in the positioning groove 812, so that the positioning slice 81 would not be moved or slipped in usage.

What is claimed is:

1. A cable pliers structure, comprising:
a left plier body and a right plier body, wherein the left plier body is pivotally connected to the right plier body, the left plier body has a first position where the left plier body keeps a predetermined distance from the right plier body and a second position where the left plier body leans against the right plier body, and an adjusting region is formed at one end of the right plier body;
a drive seat, movably disposed at one side of the adjusting region, wherein one end of the drive seat is connected to the left plier body;
a pressing block, disposed at the top of the drive seat; and
a clamping component, having a bearing base, a clamp base, and an adjusting rod, wherein the bearing base is locked at one end of the adjusting region and is adjacent to the drive seat; the clamp base is disposed at the other end of the adjusting region and has a clamping hole corresponding to the position of the pressing block; and the adjusting rod is screwed through the clamp base and connected to the bearing base, and when the adjusting rod is rotated, the clamp base moves relative to the pressing block.

2. The cable pliers structure according to claim 1, wherein the clamp base has a guide screw hole, and the adjusting rod is a bolt screwed in the guide screw hole.

3. The cable pliers structure according to claim 1, wherein the clamp base has a positioning screw hole, the adjusting region further has a guide hole with a positioning screw disposed therein, and the positioning screw passes through the guide hole and is screwed in the positioning screw hole of the clamp base, so that the clamp base is disposed in the adjusting region.

4. The cable pliers structure according to claim 1, wherein the bearing base has a through hole, the adjusting rod has a connecting screw hole at one end thereof, the clamping component further has a bolt, and the bolt passes through the through hole in the bearing base and is screwed in the connecting screw hole of the adjusting rod, so that the adjusting rod and the bearing base are connected with each other.

5. The cable pliers structure according to claim 1, wherein the bearing base has a screw hole, the right plier body further has a screw, and the screw passes through the right plier body and is screwed in the screw hole, so that the bearing base is locked to the right plier body.

6. The cable pliers structure according to claim 1, further comprising a connecting rod with two ends respectively connected to the left plier body and the right plier body and an elastic element with two ends respectively connected to the right plier body and the drive seat.

7. The cable pliers structure according to claim 1, wherein the drive seat further has a via hole, the left plier body has a locking hole, the right plier body has an elongate hole corresponding to the locking hole, and a latch is disposed in the elongate hole and passes through the elongate hole, the locking hole, and the via hole, so that the left plier body, the right plier body, and the drive seat are jointed together and have an actuation relation with each other.

8. The cable pliers structure according to claim 7, further comprising a stopping element, movably disposed on the right plier body, wherein when the left plier body leans against the right plier body in the second position, one end of the stopping element seizes the latch, so that the left plier body is attained in the second position leaning against the right plier body, and the stopping element has a pulling portion at the other end.

9. A cable pliers structure, comprising:
a left plier body and a right plier body, wherein the left plier body is pivotally connected to the right plier body, the left plier body has a first position where the left plier body keeps a predetermined distance from the right plier body and a second position where the left plier body leans against the right plier body, and an adjusting region is formed at one end of the right plier body;
a drive seat, movably disposed at one side of the adjusting region, wherein the one end of the drive seat is connected to the left plier body;
a positioning slice, pivotally disposed at the top of the drive seat and having a plurality of positioning holes; and
a clamping component, having a bearing base, a clamp base, a clamping part, and an adjusting rod, wherein the bearing base is locked at one end of the adjusting region and is adjacent to the drive seat; the clamp base is disposed at the other end of the adjusting region and has a clamping hole corresponding to the position of the positioning hole; the clamping part is pivotally disposed at the top of the clamp base and forms a clamping region corresponding to the clamping hole; and the adjusting rod is screwed through the clamp base and connected to the bearing base, and when the adjusting rod is rotated, the clamp base moves relative to the pressing block.

10. The cable pliers structure according to claim 9, wherein the clamp base has a guide screw hole, and the adjusting rod is a bolt screwed in the guide screw hole.

11. The cable pliers structure according to claim 9, wherein the clamp base has a positioning screw hole, and the adjusting region further has a guide hole with a positioning screw disposed therein, and the positioning screw passes through the guide hole and is screwed in the positioning screw hole of the clamp base, so that the clamp base is disposed in the adjusting region.

12. The cable pliers structure according to claim 9, wherein the bearing base has a through hole, the adjusting rod has a connecting screw hole at one end thereof, the clamping component further has a bolt, and the bolt passes through the through hole in the bearing base and is screwed in the connecting screw hole of the adjusting rod, so that the adjusting rod and the bearing base are connected with each other.

13. The cable pliers structure according to claim 9, wherein the bearing base has a screw hole, the right plier body further has a screw, and the screw passes through the right plier body and is screwed in the screw hole, so that the bearing base is locked to the right plier body.

14. The cable pliers structure according to claim 9, wherein the clamping part has a spring, a first piece, and a second piece, the first and second pieces are pivotally disposed on the clamp base and respectively have a first groove and a second groove corresponding to the clamping hole to form the clamping region, and the spring is disposed between the first and second pieces and respectively connected to the first and second pieces.

15. The cable pliers structure according to claim 9, wherein the positioning slice has a plurality of positioning grooves corresponding to the positioning holes respectively, the drive seat has a buried cavity with a spring and a bead mounted therein, and the bead is selectively chucked in the positioning grooves.

16. The cable pliers structure according to claim 9, wherein the positioning slice has a pivot hole, the drive seat has a screw hole and a screw, and the screw passes through the pivot hole and is screwed in the screw hole, so that the positioning slice is pivotally disposed on the drive seat.

17. The cable pliers structure according to claim 9, further comprising a connecting rod with two ends respectively connected to the left plier body and the right plier body and an elastic element with two ends respectively connected to the right plier body and the drive seat.

18. The cable pliers structure according to claim 9, wherein the drive seat further has a via hole, the left plier body has a locking hole, the right plier body has an elongate hole corresponding to the locking hole, and a latch is disposed in the elongate hole and passes through the elongate hole, the locking hole, and the via hole, so that the left plier body, the right plier body, and the drive seat are jointed together and have an actuation relation with each other.

19. The cable pliers structure according to claim 18, further comprising a stopping element, movably disposed on the right plier body, wherein when the left plier body leans against the right plier body in the second position, one end of the stopping element seizes the latch, so that the left plier body is attained in the second position leaning against the right plier body, and the stopping element has a pulling portion at the other end.
